(19) United States
(12) Patent Application Publication
(10) Pub. No.: US 2011/0031816 A1
(43) Pub. Date: Feb. 10, 2011

(54) PHOTOVOLTAIC UNIT, A DC-DC CONVERTER THEREFOR, AND A METHOD OF OPERATING THE SAME

(75) Inventors: Henricus Cornelis Johannes Buthker, Mierlo (NL); Klaas de Waal, Waalre (NL); Hendrik Johannes Bergveld, Eindhoven (NL); Gian Hoogzaad, Mook (NL); Franciscus A. C. M. Schoofs, Valkenswaard (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/846,697

(22) Filed: Jul. 29, 2010

(30) Foreign Application Priority Data
Jul. 30, 2009 (EP) 09166852.5

(51) Int. Cl. H02J 1/00

(52) U.S. Cl. 307/82

(57) ABSTRACT

A photovoltaic unit is disclosed comprising a plurality of sub-units connected in series, each sub-unit having a main input and a main output, which main output is connected to the respective main input of a neighbouring sub-unit, each sub-unit further comprising a segment comprising one or more series-connected solar cells, and a supplementary power unit, wherein the supplementary power unit is configured to at least one of receive power from or supply power to the neighbouring sub-unit. The supplementary power unit is preferably a DC-DC converter, and arranged to exchange energy between neighbouring segments, without requiring a high-voltage connection across the complete string (of more than 2 segments). The converter may be inductive or capacitive.

A DC-DC converter configured for use in such a unit is also disclosed, as is a method of controlling such a photovoltaic unit.

### FIELD OF INVENTION

This invention relates to photovoltaic units and to methods of operating photovoltaic units.

### BACKGROUND OF INVENTION

A photovoltaic cell (hereinafter also referred to as a solar cell) is a device which directly converts light such as sunlight into electricity. A typical such device is formed of a p-n junction in a semiconductor material. In operation, one surface of the device is exposed to light typically through an anti-reflective coating and protective material such as glass. Contact to this surface is made by a pattern of conductive fingers typically of a metal such as aluminium. Electrical contact to the other side of the p-n junction is typically provided by a continuous metal layer.

Photovoltaic (PV) systems, typically made of several hundreds of solar cells, are increasingly used to generate electrical energy from solar energy falling on solar modules, hereinafter also referred to as solar panels. Generally, each solar module is formed by placing a large number of solar cells in series. A PV system is then formed by placing a number of solar modules in series, to create a string and sometimes by placing multiple strings of in-series-connected solar modules in parallel, depending on the desired output voltage and power range of the PV system.

In practical cases, differences will exist between photogenerated currents, and output powers, of individual solar cells in the various modules, e.g. due to (part of) the modules being temporarily shaded, pollution on one or more solar cells, or even spread in solar cell behaviour—for instance due to manufacturing variations or to differences in the rate of degradation of performance of cells during aging. Due to the current-source type behaviour of solar cells and their series connection these differences can lead to a relatively large drop in output power coming from a PV system, as will be explained in more detail herebelow.

If one or more cells in a module produce a lower photo-generated current than the remaining cells, for instance due to partial shading, the current-matching constraint resulting from the series connection of the cells can force these lower current cells into reverse bias until their respective diode reaches reverse breakdown. This can result in significant reverse bias being developed across the cell (or cells), and potentially damaging power dissipation in the shaded cells. In order to limit this power dissipation, it is well-known to include a bypass diode across a group, also hereinafter referred to as segment, of cells.

Whether or not a bypass diode is used across the segment, partial shadowing to even one or two cells can severely restrict, or even prevent, the whole segment from contributing power to the overall system.

Applicant's co-pending International Patent Application IB2009/053001 (attorney docket: 81382083), which is not pre-published, and the whole contents of which are included herein by reference, discloses an arrangement wherein a photovoltaic unit, comprising a plurality of series-connected segments, is provided with one or more supplementary power units, each in parallel with a segment, the segment comprising a series-connected group of solar cells. The supplementary power unit is operable to provide additional current in parallel with cells of a segment which has lower current (at its optimum—“maximum power” operating point), than other series-connected segments. The loss in power attributable to a segment having one or more partially shaded cells, can thereby be significantly reduced.

The supplementary power units of IB2009/053001 are preferably configured as DC-DC converters, the input power for which is provided from the series-connected string of segments. However, in such an arrangement a high voltage connection (having the full string voltage) is required for each DC-DC converter, or alternatively, an intermediate converter is required to reduce the voltage to a level closer to that of each segment, along with voltage isolators, to allow level shifting of the voltage. Provision of either high-voltage converters or the additional intermediate converter is undesirable, as it results in additional costs to the system.

DE 10219956 discloses a solar system in which a half bridge DC/DC converter (“balance transducer 14”) is arranged connected across two neighbouring solar units with a connection therebetween, and configured to maximise the output power from the two neighbouring modules by means of a controlling the voltage across them to a predetermined ratio, US 2005/0139258 discloses a solar cell array control device, which comprises a bidirectional DC-DC flyback converter, EP 1081824 discloses a method and apparatus for equalising voltages over capacitors in a series connection capacitors during charging and discharging.

There thus remains a need for a photovoltaic unit which reduces or eliminates power wastage arising from shadowing but does not require a high voltage DC-DC converter, or voltage-isolated converters.

### SUMMARY OF INVENTION

It is an object of the present invention to provide a photovoltaic unit in which losses due to differential currents between individual cells or sub-units is reduced.

According to a first aspect of the present invention there is provided a photovoltaic unit comprising a plurality of sub-units connected in series, each sub-unit having a main input and a main output, which main output is connected to the respective main input of a neighbouring sub-unit, each sub-unit further comprising a segment comprising one or more series-connected solar cells, and a supplementary power unit, wherein the supplementary power unit is configured to at least one of receive power from or supply power to the neighbouring sub-unit. Preferably, the supplementary power unit is configured to at least one of source current to and sink current from the main output of the respective sub-unit.

In embodiments, the supplementary power unit has a first pair of terminals and a second pair of terminals, the first pair of terminals being connected one to each of the main input of the respective sub-unit and the main output of the neighbouring sub-unit, and the second pair of terminals being connected one to each of the main input of the respective sub-unit and the main output of the respective sub-unit. It will be appreciated by the skilled person that the first pairs of terminal thus operate as input terminals and the second pair of terminals operate as output terminals, when the supplementary power unit is a down converter or a bi-directional converter operating as a down converter; conversely, the first pair of terminals operate as output terminals and the second pair of terminals operate as input terminals, when the supplementary power unit is an up converter or a bi-directional converter operating as an up converter.

In particularly preferred embodiments, the supplementary power unit comprises at least a DC-DC converter. Thus, the supplementary power unit may comprise more than one DC-DC converter; this may particularly be the case in embodiments in which each DC-DC converter is either an up converter or a down converter. Preferably, the DC-DC converter comprises two series-connected switches connected between the input terminals and having a half-bridge node therebetween, and an inductor connected between the half-bridge node and the main output of the respective sub-unit.

In embodiments, the photovoltaic unit further comprises a capacitor connected between the main input and the main output of the respective sub-unit. Absent some sort of smoothing reactive component such as a capacitor, there is likely to be too much voltage variation, resulting in losses since the segment may then at times operate significantly off its maximum power operating point

In embodiments, the supplementary power unit further comprises control means for controlling the series-connected switches. Preferably, the control means is configured to control the switches such that the supplementary power unit operates as a half-bridge converter. A half bridge converter is a particularly efficient converter to use for this application.

Preferably, the control means comprises a communication interface to the neighbouring sub-unit. In embodiments, the control means further comprises a level shifter. This can be useful in order to enable multiple controllers (one in each supplementary power unit) to be connected in series by means of the communication interface.

In embodiments the supplementary power unit comprises a capacitor, a first electrode of which is arranged to be switchably connectable to either the main input or the main output of the respective sub-unit, and a second electrode of which is arranged to be switchably connectable to either the main output of the respective sub-unit or the main output of the neighbouring sub-unit. The supplementary power unit may further comprise control means for controlling the switching of the capacitor. The supplementary power unit may then further comprise first, second, third and fourth switches, the photovoltaic unit further comprising control means operable to sequentially connect the capacitor across either the sub-unit or the neighbouring subunit by means of the first and second switches, and the third and fourth switches, respectively. The supplementary power unit can thus operate as a capacitive converter.

In embodiments, the supplementary power unit is disabled if the node between the sub-unit and the neighbouring sub-unit is within a predetermined voltage window around half the voltage between the input of the sub-unit and the output of the neighbouring sub-unit. Thus, bouncing between up-converter and down-converter modes may be avoided, and the power consumption involved in operating the supplementary power unit may be avoided, should this consumption be higher than the power gain achievable from nearly-matched modules. Furthermore, such a window may also be effective in allowing voltage variation between sub-units caused by temperature differences, rather than by insolation variation, without triggering operation of the supplementary power unit,

According to another aspect of the present invention, there is provided a DC-DC converter configured as the supplementary power unit for use in a photovoltaic unit as described above, and comprising a power interface for exchanging power with a neighbouring supplementary power unit and a communication interface for exchanging control information with a neighbouring supplementary power unit, wherein the power interface comprises the pair of output terminals arranged for connection to a pair of input terminals of a neighbouring supplementary power unit.

According to a yet further aspect of the present invention, there is provided a method of operating a photovoltaic unit comprising a plurality of sub-units, each sub-unit comprising a main input and a main output, which main output is connected to the respective main input of a neighbouring sub-unit, the sub-unit further comprising a segment comprising one or more series-connected solar cells, and a supplementary power unit, the method comprising determining a segment power generated by the sub-unit's segment, determining a neighbouring power generated by the segment of the neighbouring sub-unit, and operating the supplementary power unit to exchange power between the sub-unit and the respective neighbouring sub-unit in dependence on the difference between the segment power and the neighbouring power.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 illustrates, at 1(a)) a single-diode model of a photovoltaic device, at 1(b) the operating characteristic of a photovoltaic device, both in the dark and illuminated, at 1(c) part of the operating characteristic in more detail, and at 1(d) graphs showing the influence of illumination level of the operating characteristic;

FIG. 2 shows operating characteristics of multiple solar cells connected in series;

FIG. 3 shows in schematic form the layout of a typical photovoltaic module;

FIG. 4 shows photovoltaic modules having shadows thereon;

FIG. 5 shows a pair of series connected solar cells having current sources connected in parallel thereto;

FIG. 6 shows, in schematic form, a string of sub units, each sub unit comprising a segment of series-connected solar cells and a DCDC converter;

FIG. 7 shows the series connected solar cells of FIG. 5, but having an energy storage element connectable in parallel thereto according to embodiments of the invention;

FIG. 8 shows a pair of series-connected segments having a DC-DC converter connected thereto;

FIG. 9 shows a more detailed version of FIG. 8, including a controller, as part of the DC-DC converter;

FIG. 10 shows the IV and PV operating characteristics of fully illuminated and partially shaded segments, when operated according to the schema of FIG. 9;

FIG. 11 shows simulations of operating characteristics of a fully illuminated, and partially shaded segment at 11a and 11b respectively;

FIG. 12 shows simulations of IV and PV characteristics of a series-connection of the modules of FIG. 11, at 12(a) without any delta converter, and at 12b with a delta converter in operation;

FIG. 13 shows a module of three series-connected segments with two DC-DC converters connected thereto;

FIG. 14 shows a photovoltaic unit comprising two modules as shown in FIG. 13, and including additional converters arranged to connect the modules;

FIG. 15 shows the operation of a simplified exemplary module including DC-DC converters;

FIG. 16 shows a pair of segments with a DC-DC converter including temperature sensing;

FIG. 17 shows schematically a capacitive based for energy exchange between neighbouring segments; and

FIG. 18 shows schematically an implementation of a capacitive energy exchange between two segments,

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

### DETAILED DESCRIPTION OF EMBODIMENTS

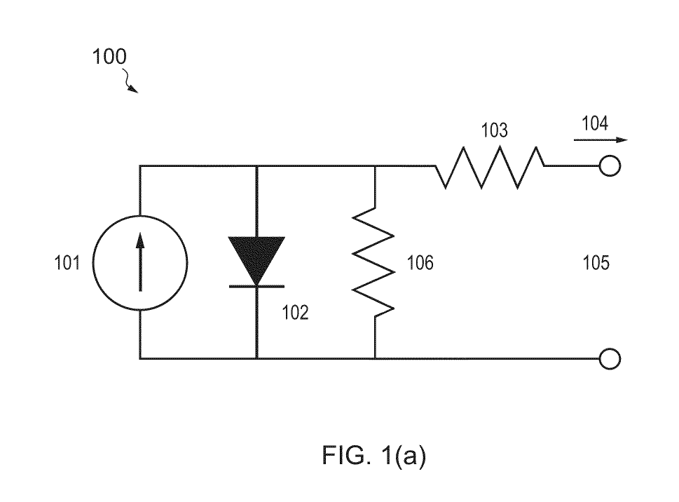

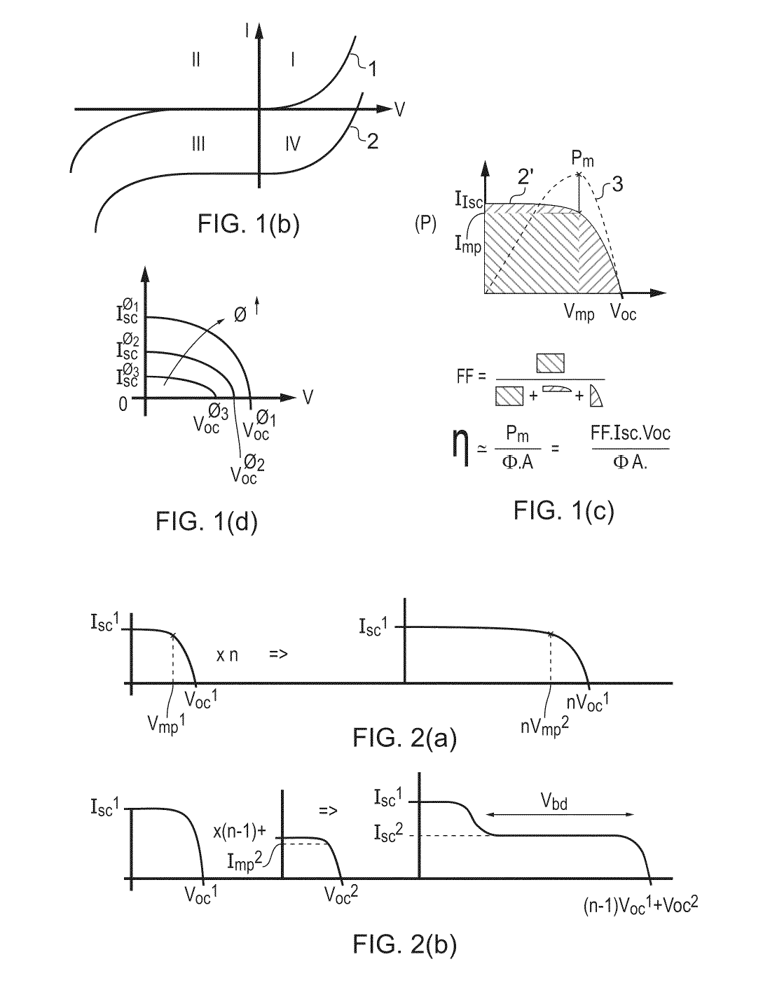

FIG. 1 shows the equivalent circuit 100 which is most often used to model the performance of a solar cell (the so-called single-diode model). A current source 101 corresponding to the photo-generated current (also referred to hereinafter as insolation current) Iins is in parallel with a diode 102 and shunt (that is, parallel) resistance Rp at 106. That part of Iins which does not flow through the diode or shunt resistance flows to an output node via the low-ohmic series resistance Rs 103 (typically a few mΩ per cell). Some internal leakage occurs via the high-ohmic shunt resistance Rp (typically in a kΩ to MΩ range).

Its accompanying I-V characteristic is shown in FIG. 1b, for the case where the photo-generated current Iins is zero (curve 1) corresponding to no irradiation, and non-zero (curve 2) corresponding to an irradiated cell. As shown in the un-irradiated case, the IV characteristic is that of a diode with shunt and series resistances, and lies in the first and third quadrants of the IV plane; introduction of irradiation due to e.g. insolation translates the IV characteristic downwards, into the IV (that is, fourth) quadrant of the IV plane. Normally, the (IV-quadrant) part of the characteristic which is of most interest in photovoltaics is shown inverted, as can be seen on FIG. 1(c) at 2′ along with the corresponding power-voltage (P-V) curve 3.

When the cell is shorted, an output current I of a cell equals the value of the current source (Iins=short−circuit current Isc in the I-V characteristic in FIG. 1c), less current though the shunt resistance 106—which is usually negligible. Basically, the output current is linearly proportional to the amount of incoming light for light conditions exceeding 100 W/m2, which is typical for most cases during outdoor use. When left open-circuit, current Iins will flow mostly into the diode leading to an open-circuit voltage Voc, which for a polycrystalline silicon cell may typically be roughly 0.6 V, see FIG. 1c.

As can be seen, there is a single point on the IV curve which produces maximum power (at the voltage corresponding to the maximum power peak Pm of the P-V curve). In the Figure are shown short-circuit current Isc and open-circuit voltage Voc, along with the current (Imp) and voltage (Vmp) at the maximum power point (MPP). Thus Pm=Imp*Vmp, and is related to the product of Isc and Voc by means of the fill factor FF: Pm=Isc*Voc*FF. FIG. 1(c) also shows the conversion efficiency 11, and the relation between efficiency and irradiance (Φ).

FIG. 1(d) shows the change (in the IV-quadrant) of the IV characteristic with varying irradiance Φ. The short-circuit current Isc scales linearly with increasing illumination Φ as shown at Isc φ1, Isc φ2 and Isc φ3. The open-circuit voltage Voc increases slowly with increasing irradiance Φ, as shown at Voc φ1, Voc φ2 and Voc φ3.

Since a cell's output current depends e.g. on the amount of incoming light (insolation) and further cell behaviour is also temperature dependent, as a consequence the current and voltage value at which maximum power is obtained from a cell varies with environmental conditions. Therefore, in order to obtain a maximum output, in any practical solar system preferably this maximum power point needs to be continuously updated, which is referred to as Maximum-Power-Point Tracking (MPPT). In a sub-optimal configuration this is usually performed for all solar cells simultaneously.

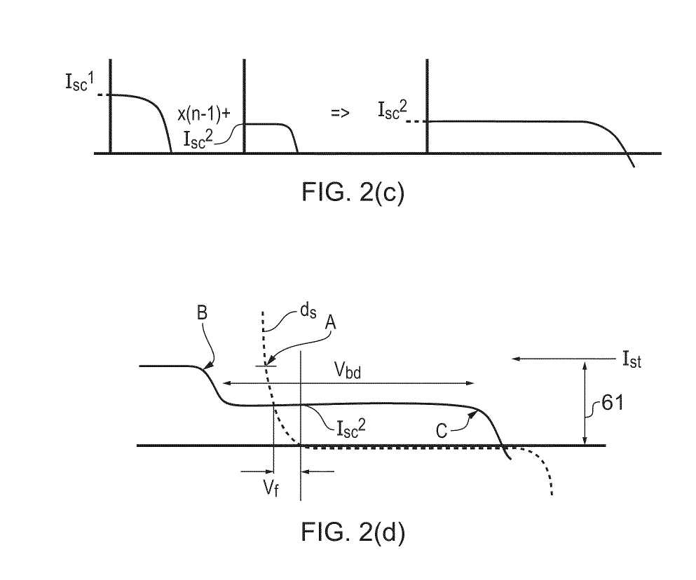

As already mentioned, in order to provide useful power, in most applications solar cells are connected in series, in a module or sub-unit. The possible resulting IV characteristics are illustrated schematically in FIG. 2. Since the cells are series connected, the current through each cell must be the same. FIG. 2(a) shows the situation where each cell has the same characteristic, under the same illumination conditions. Then, the module IV characteristic is simply a stretched (in the voltage direction) version of the individual cell characteristic: If each cell has short-circuit current, open-circuit voltage, max power voltage and max power of, respectively, Isc1, Voc1, Vmp1 and Pmax1, then the module has respective short-circuit current, open-circuit voltage, max power voltage and max power of Isc1, n*Voc1, n*Vmp1 and n*Pmax1.

However, if one of the cells has a lower short-circuit current Isc2 (and open-circuit voltage Voc2), as shown schematically, and slightly simplified, in FIG. 2(b), then when the other cells are producing current Isc1, that cell will be driven into reverse bias until it starts to break down, (with a reverse bias of Vbd). The current-matching constraint results in an IV characteristic with a further “knee”, which lies to the left of the original max-power knee, by a voltage of Vbd. To the left of this further knee, the characteristic slopes up to Isc1 with a slope dependant on the reverse breakdown of the lower current cell; between this knee and the original Vmp (ie n*Vmp1), the current is Isc2. The module open-circuit voltage is (n−1)*Voc1+Voc2, which is approximately n*Voc1, and the right-hand max power point is still approximately at n*Vmp1.

As shown, the lower current cell starts to reverse breakdown with a sufficiently low Vbd, that the further “knee” is to the right of the axis. However, where the cell has a high Vbd, the knee could be to the left of the axis—and thus does not form part of the IV-quadrant characteristic. This is shown schematically in FIG. 2(c).

In practice, many reasons exist why an output current of one cell will not be equal to that of another. Examples are shading, local contaminations on a module (e.g. bird droppings, leafs, etc), and spread between cells (aggravated by aging). The most prominent is that of (partial) shading, where one or more cells in one or several modules receive less incoming light than others, leading to lower Iins values than that of other cells. In practice, shading of a cell may lead to 40-70% less incoming light than cells that have no shadow across them. In practical systems, partial shading may only occur during a certain part of the day and most of the day all cells will be in bright sunlight.

FIG. 2(d) shows the IV characteristic of a similar module (or segment), as that in FIG. 2(a), but including a lower current cell with a high reverse breakdown. The lower current cell has short-circuit current Isc2. Where there is an external constraint (such as one or more further series-connected module) forcing Isc1 through the module, the whole module could be forced into reverse bias. In conventional modules, this is prevented by the inclusion of a “bypass diode” in anti-parallel with the module. If the module is driven into reverse bias, the bypass diode (which then becomes forward biased) turns on, and shunts the excess current. The reverse bias across the module is limited to the diode's forward bias Vf, and the lower-current cell does not reach Vbd. Thus, where the string current through the module forces it to operate at a high current Ist (shown at 61), then instead of the module operating at the reverse breakdown voltage of the lower-current cell (ie point B in the Figure), it operates at the by-pass diode's forward voltage (point A). (It will be appreciated that, as shown in FIG. 2(d), the lower current cell may produce half the current of the fully illuminated cells. In this case, the excess current is equal to that through the lower current cell, and the current through the diode is equal to that through the lower current cell. In general, however, the diode is driven into forward voltage until its current corresponds to the excess current of the fully-illuminated cell over that of the lower current cell. Consequently, point A may be to the right or left of the position shown.)

Now, then, instead of producing the maximum possible power which could be available from this module (of approximately [n*Vmp2]*Imp2, shown at point C in FIG. 2(d)), the module consumes a power of approximately Isc1*Vf, as shown at point A in FIG. 2(d). This corresponds to a significant drop in efficiency for the photovoltaic system as a whole. Since, absent the bypass diode, the string module could otherwise be driven even further into reverse bias (shown at point B), it can be seen that the bypass diode thus protects the lower-current cell from potentially damaging high reverse bias, (the so-called “hot-spot” phenomenon), whilst at the same time it limits, but does not eliminate, the power loss in the system which results from the current mis-match.

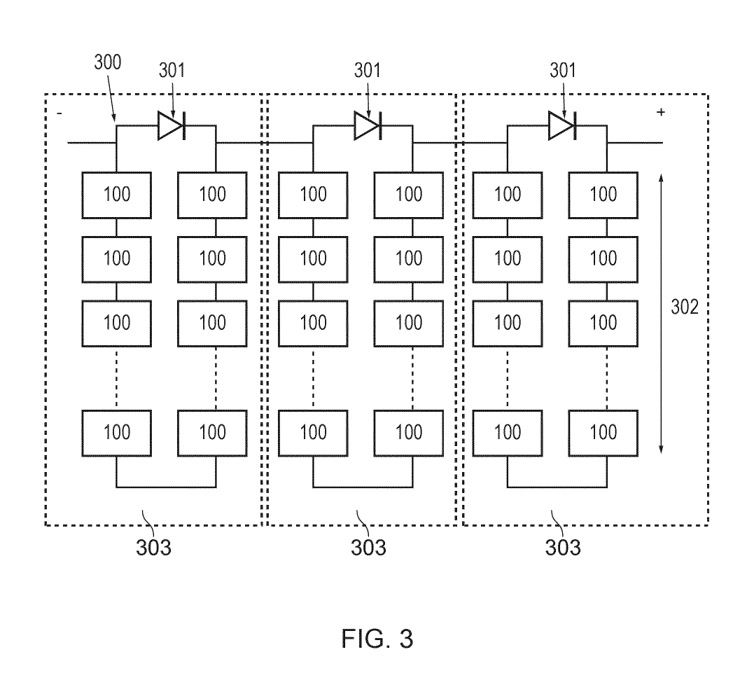

A conventional arrangement for a PV system is shown in FIG. 3. A solar module 300 consists of perhaps 54-72 cells 100 in series, typically arranged in a meander-type fashion with a width 302 of 9-12 cells and one bypass diode 301 per segment of 18-24 cells. The number of cells per bypass diode is typically coupled to the breakdown voltage of the solar cells used. Segments 303 each comprising one group of solar cells and a bypass diode 301 are indicated as well. The 3 diodes in FIG. 3 are typically placed in a junction box (not shown) including a heat sink that is placed on the backside of each module.

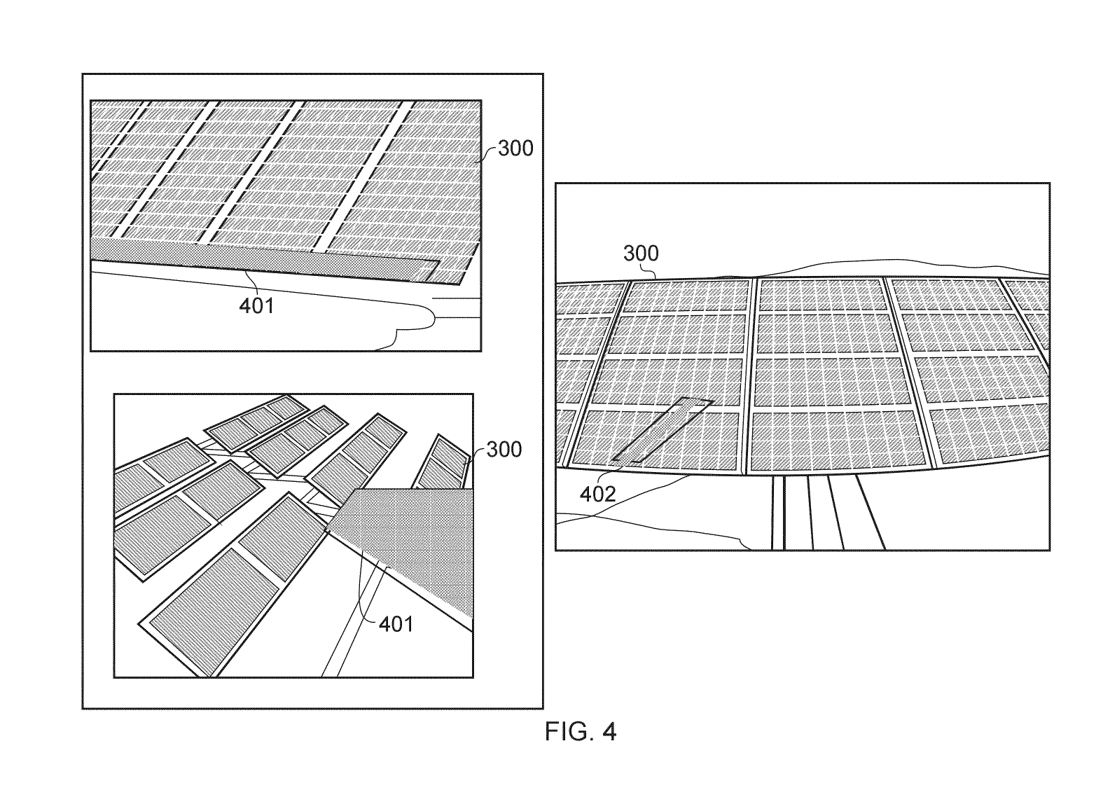

Some examples of modules 300, which are partially shadowed by other module shadows 401 or by antenna shadows 402, in practical PV systems are shown in FIG. 4. As can be seen, only small portions of the modules therein are in the shade. As will be explained below, this will lead to a relatively large decrease in output power of the PV system in question.

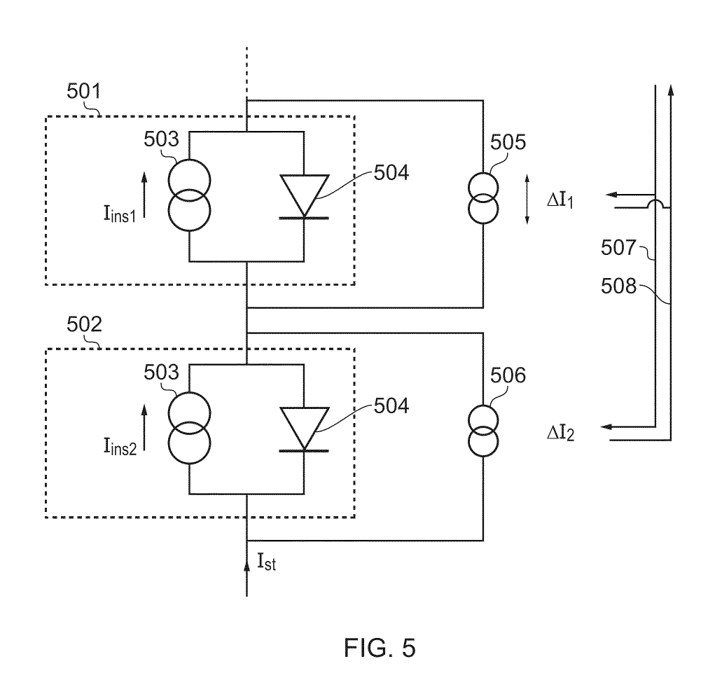

The above-described problem of output differences between PV modules in a PV system and the associated power drop is clearly recognized in the field. As described in IB2009/053001, various solution routes are available to deal with the problem of output-power decrease due to mismatch (hardware or insolation) between solar cells in a PV system. These solution routes include module-level DC-DC converters, string-level DC-DC converters and module-level DC/AC converters (micro inverters). A distinction can be made between ‘sigma’ module-level DC-DC converter concepts, where individual PV modules are connected to individual DC-DC converters that are in turn connected in series, and ‘delta’ DC-DC converters that can be placed per cell or group of cells. The ‘delta’ DC-DC converter was introduced in IB2009/053001 and its basic conception is shown in FIG. 5, applied on solar-cell level. It should be noted that in general, the concept would not be implemented at the level of an individual solar cell, but at the level of groups of cells; however, the single cell example is useful in providing an understanding of the invention. FIG. 5 shows 2 solar cells 501, 502, each depicted as a current generator 503 and diode 504. For simplicity, the series and shunt resistances are neglected. The cells produce respective currents Iins1 and Iins2, and are series-connected. Connected in parallel across the cells are supplementary power units 505 and 506 respectively. The supplementary power units, which are shown in this example as current generators, supply (or sink) additional currentsΔI1 and ΔI2 respectively in parallel to the photo-generated currents Iᵢₙₛ₁ and Iᵢₙₛ₂. Thus, if Ist is the current through the string,

Iᵢₙₛ₁+ΔI1=Ist, and

Iᵢₙₛ₂+ΔI2=Ist.

As shown by arrows 507 and 508, the current difference between each solar cell, and the string, is either replenished from a central source or fed back to the central source. As a result, the total energy obtained from the PV system is increased, relative to the case where the lowest cell current determines the power output from each of the cells.

As described in, IB2009/053001, the supplementary power units are conveniently and preferably provided in the form of the DC-DC converters. Because they only convert differences in powers (or currents) the converters may conveniently be termed “delta” converters.

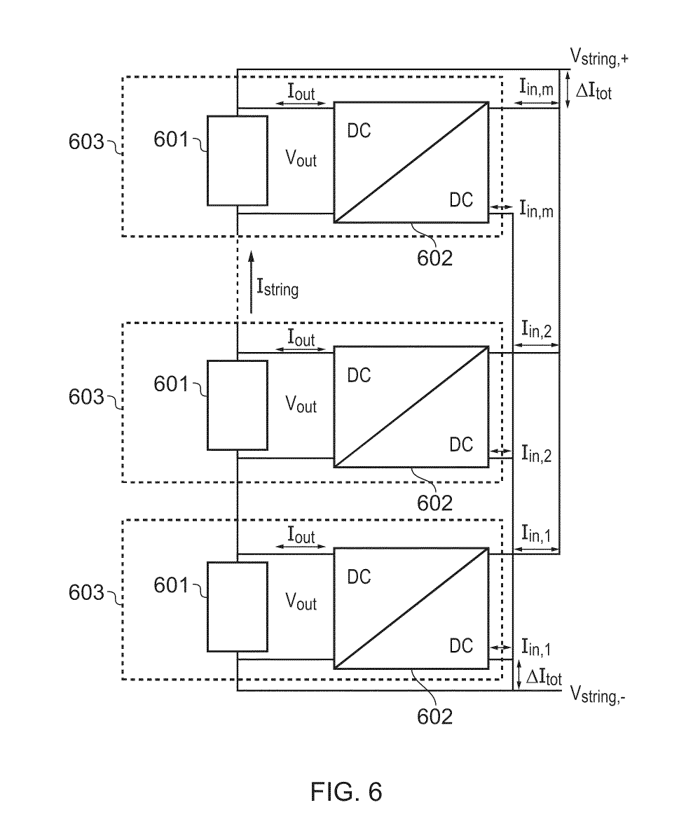

FIG. 6 shows, in schematic form, a practical configuration of delta converters in a photovoltaic unit. The figure depicts a plurality of groups of cells 601, hereinafter also called the segments, which are series-connected. Connected in parallel across each group of cells 601 is a DC-DC converter 602, which acts as a current source. Each segment 601 and current source 602 form a sub-unit 603. Since the groups of solar cells themselves remain connected in series, this implies that the DC-DC converters implementing these current sources need to have both output nodes isolated from both input nodes. As shown in the figure, the delta converters are supplied by the string voltage. This implies that the positive inputs of the DC-DC converters are all connected to the positive string supply, whereas all the negative inputs are connected to the minus string supply. In the case that one of the DC-DC-converter output nodes is connected to one of the DC-DC-converter input nodes, such as would be the case for a non-isolated DC/DC converter, part of the string of modules or cells would be shorted.

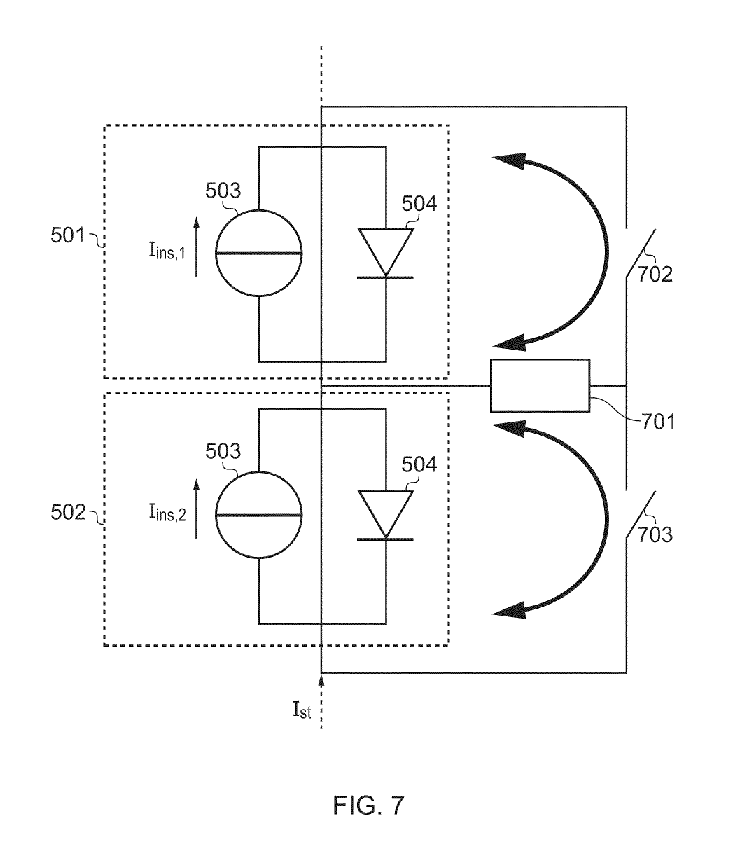

A photovoltaic unit according to an embodiment of the invention is shown in FIG. 7. In the figure is shown two solar cells 501 and 502, each of which may be considered as a current source 503 in parallel with a diode 504. The photo-generated current from the cells is respectively Iins1 and Iins2. The cells are series-connected and form part of a string which carries string current Ist. Connected to the node between the two cells 501 and 502 is an energy storage element 701. The energy storage element 701 can be connected in parallel with either of the cells 501 and 502 by means of switches 702 and 703 respectively. The energy storage element 701 can be used to “harvest” energy (or, equivalently, power) from one solar cell and supplement the energy (power) provided by the other solar cell. In other words, energy is locally exchanged between neighbouring parts of the photovoltaic system. It should be noted that “energy exchange” will be used equivalently to “power exchange” herein, since the energy is merely the integral of the power, and, considered as an overall DC system, these may be treated as equivalent (over unit time).

The energy storage element 701 and switches 702 and 703 typically form a, or part of a, DC-DC converter. Further, in most practical embodiments of the individual solar cell 501 and 502 are replaced by a group of solar cells, as discussed with reference to FIG. 5.

Thus, as shown, the DC-DC converter implementing the energy-exchange function is supplied by the two groups of cells around which it is arranged and not by the complete string or an intermediate voltage.

By locally exchanging energy between two neighbouring groups of cells the energy output of all groups of cells in a string are emulated to be equal. This effect is the same as that obtained by the solution discussed above with reference to FIG. 5. A difference, however, is that no isolated DC/DC converter is needed. Moreover, only low-voltage switches are needed and the control method is considerably simplified.

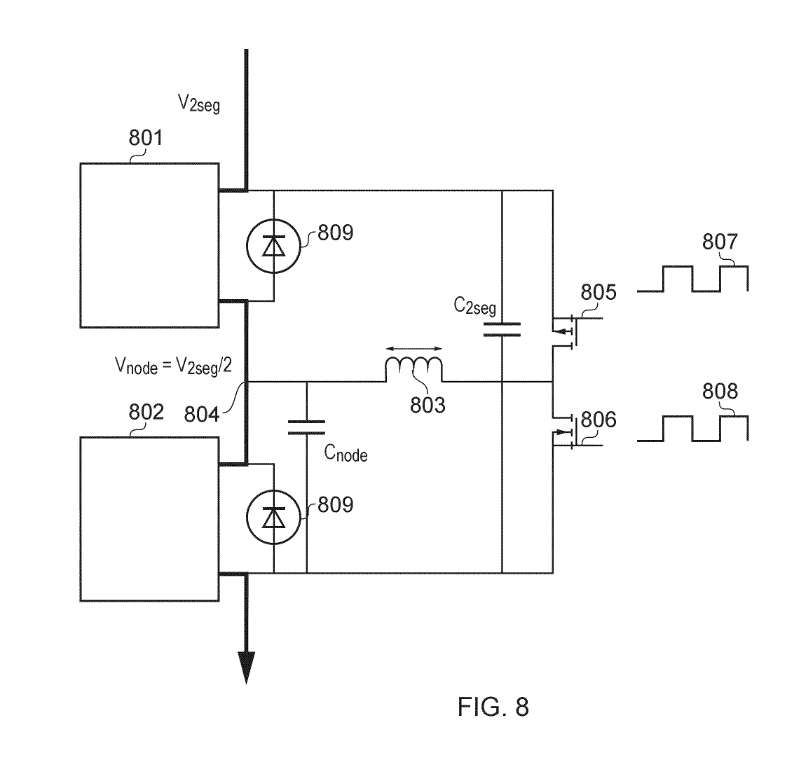

In FIG. 8 is shown one embodiment of the invention which provides a basic implementation of the concept schematically shown in FIG. 7. The figure shows two segments 801 and 802 each comprising a group of solar cells and which are connected in series. One end of an inductor 803 is connected to the node 804 between the two segments. The inductor 803 is connectable across the first segments by means of power switch 805, and connectable across the second segment by means of power switch 806. A first capacitor C2seg is connected across both segments, and a second capacitor Cnode is connected across the lower segment 802. In addition, by-pass diodes 809 are connected across each of the segments. This implementation thus comprises a half-bridge converter (although, in other embodiments, other known converters are also possible).

In operation, the power switches in the half bridge are controlled such that the node voltage Vnode between the two segments is half of the voltage V2seg across the two segments. As a result, the voltages across the two segments are effectively equalized. The DC-DC converter is implemented as a bi-directional converter. This implies that when e.g. the voltage across lower segment 802 is lower than the voltage across upper segment 801, the converter will act as a DC-DC down converter and will source current into the node in between the two segments. Effectively current is now fed from the upper segment 801 to the lower segment 802, enabling a higher output power of the two segments. The reason is that without the DC-DC converter, lower segment 803 would be bypassed because of its lower associated current level than upper segment 801. With the DC-DC converter, power from the upper segment 801 is used to supplement the current from segment 802, as a result of which both segments can again contribute to the output power of the string/PV system. In the case where e.g. the voltage across upper segment 801 is lower than the voltage across lower segment 802, the DC-DC converter will operate as up converter and will sink current out of the node in between the two segments and use this to supplement the current through segment 801. Effectively current is now fed from segment 802 to segment 801, again enabling higher output power of the two segments in series as described above. In both cases, energy is effectively exchanged between neighbouring segments, i.e. groups of an equal number of solar cells, as shown in FIG. 7. In addition to the advantage of needing only lower-voltage switches, this implementation of a delta D-/DC converter achieves maximum power out of a string of series-connected segments without the need for complicated control schemes. Each segment DC-DC converter only needs to equalize the two segment voltages across which it is connected.

Due to the switched-mode operation of the half-bridge converter in either current direction, buffer capacitors are needed at the input and output of the converter. These capacitors have been added in the schematic of FIG. 8. The capacitors serve to keep the ripple voltages across Vnode and V2seg within reasonable limits. Note that ripple voltages on top of segment voltages lead to the segments being swept around their MPP. Therefore, the amount of ripple that is allowed depends on the desired total system efficiency. For simplicity, these capacitors have been left out of the more detailed embodiments further below. Due to the used voltage and power levels, the capacitance values will be relatively low, allowing the use of ceramic capacitors with relatively small volume.

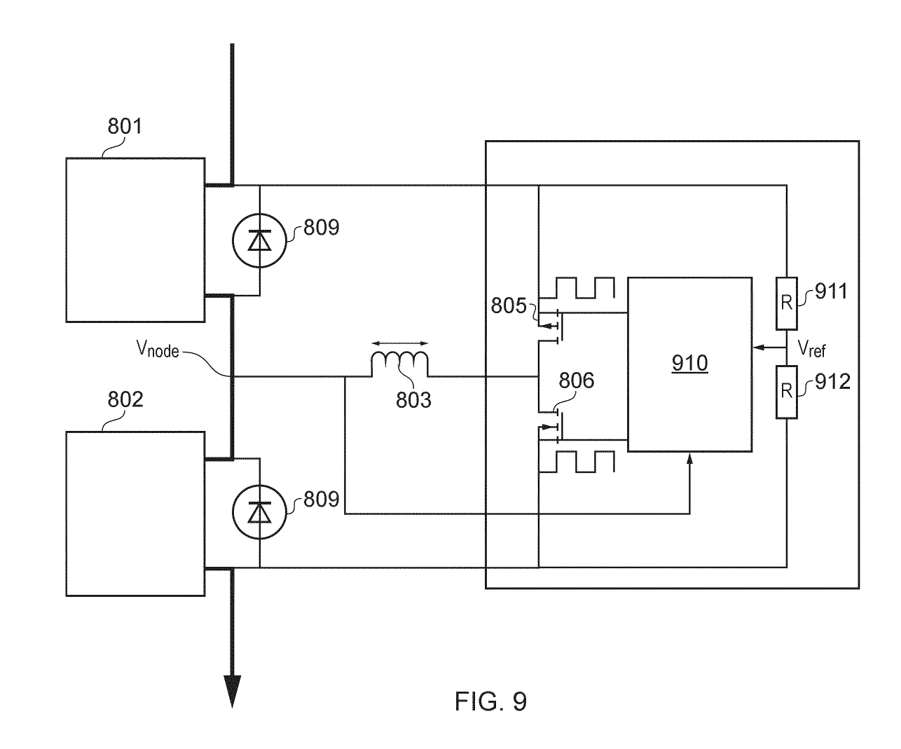

A more detailed embodiment of the half-bridge converter across two segments, including control means, is shown in FIG. 9. The basic arrangement is the same as that shown in FIG. 8 and the same reference numerals are used for the same components. A reference voltage Vref of half the voltage across two segments is derived, by a potential divider consisting of two resistors 911 and 912 having the same resistance R is used to control Vnode. By feeding both the reference voltage Vref and the node voltage Vnode to the control block inside DC-DC-converter IC 910, the current into or out of the node can be controlled such that Vnode=V2seg/2. Note that in this embodiment the switches and control block have been integrated in one IC. A different partitioning, e.g. using external MOSFETs for the power switches, is also possible, depending on the required output power level of the DC-DC converter. The primary function is that the voltage at the node between two segments is controlled to half of the voltage of two segments in series, effectively equalizing both segment voltages.

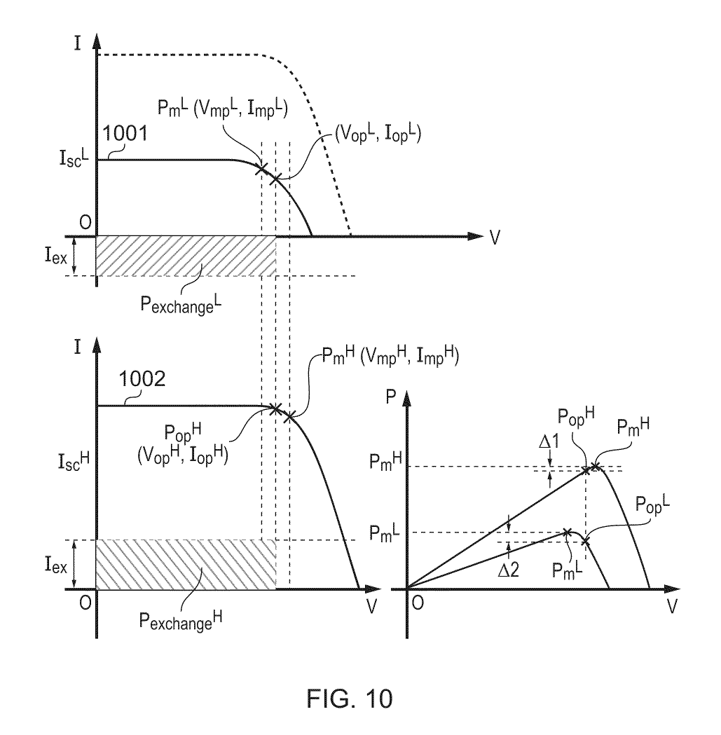

The effect of a DC-DC converter such as that shown in FIG. 9 on the operating characteristics of two segments, one of which is partially shaded, is shown in FIG. 10. FIG. 10 shows the IV characteristics 1001 and 1002 of a partially shadowed (that is, shaded) segment having short-circuit current IscL, and a fully illuminated (that is, lit) segment having short-circuit current IscH. The lit segment has a maximum power point, providing power PmH at a voltage VmpH and current ImpH. Correspondingly, the shaded segment has a maximum power point providing power PmL at the voltage VmpL and current ImpL. Also shown are the corresponding power-voltage (PV) characteristics for the two segments, on which the respective maximum power points PmH and PmL are also depicted. As discussed above, operation of the DC-DC converter has the effect of adjusting the potential Vnode between the two segments to be half the combined voltage, that is to say the operating voltage of string 1001 adjusts to VopH and the operating voltage of string at 1002 adjusts to VopL, and moreover VopH=VopL. Since the illumination conditions on each segment are unchanged, the respective IV characteristic is unchanged, and thus the operating point of each segment moves around its (unaltered) IV characteristic, to respective points (VopH, IopH) and (VopL, IopL), at which point they produce powers PopH and PopL respectively. Moreover, the operating point moves round each of the PV curves, to the left for the lit segment, and to the right for the shaded segment. As can be seen from the PV curves, the power output from the lit segment is lower than its maximum power by an amount Δ1, where Δ1=PmH−PopH. Correspondingly, the power output from the shaded segment is lower than its maximum power by an amount Δ2, where Δ2=PmL−PopL.

However, although each segment itself is now operating away from its optimum maximum power point, the effect is less marked on the sub-unit comprising the segment and the supplementary power (or current). This is shown in FIG. 10 by means of the hashed regions PexchangeH and PexchangeL. The effective IV characteristic of the sub-unit, (rather than the segment itself), containing the lit segment corresponds to the bottom curve in FIG. 10, but with a translation of the voltage axis by an amount Iex. The shaded region in the bottom curve having area PexchangeH=Iex*VopH, is equal to the power which is exchanged between the lit and shaded sub-units. Thus, provided that the DC-DC converter is 100% efficient PexchangeH=PexchangeL, where PexchangeL=Iex*VopL and is the additional area produced under the operating point of the shaded segment by means of translating the voltage axis of the shaded segment downwards by an amount Iex. Of course, for a non-ideal converter, which is less than 100% efficient, the ratio between PexchangeH and PexchangeL (or between PexchangeL and PexchangeH depending on the exchange direction) corresponds to the converter efficiency.

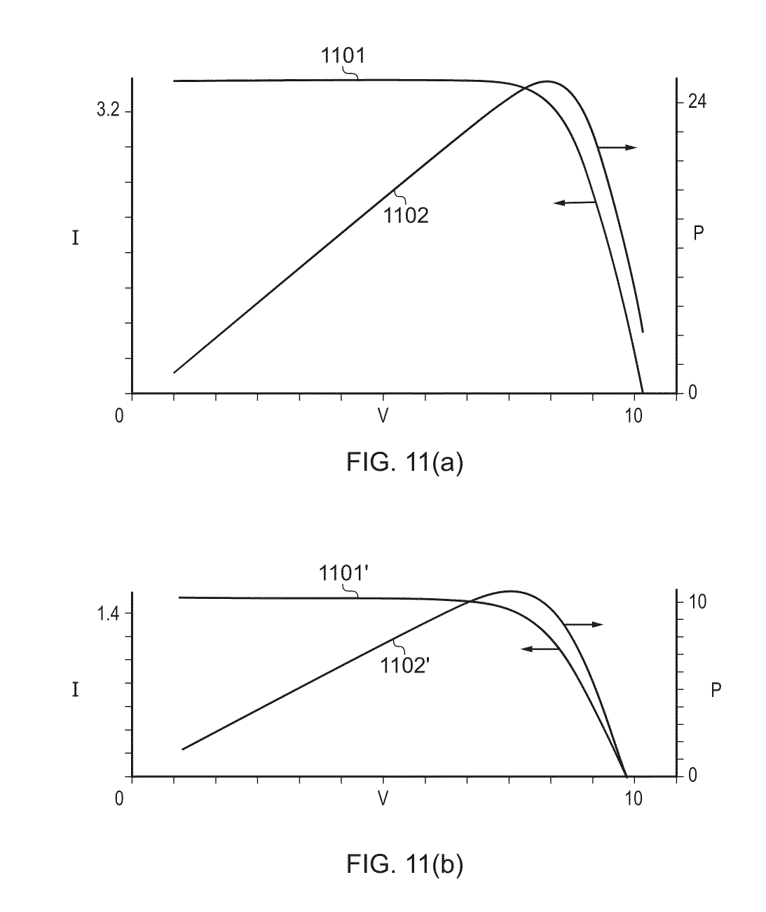

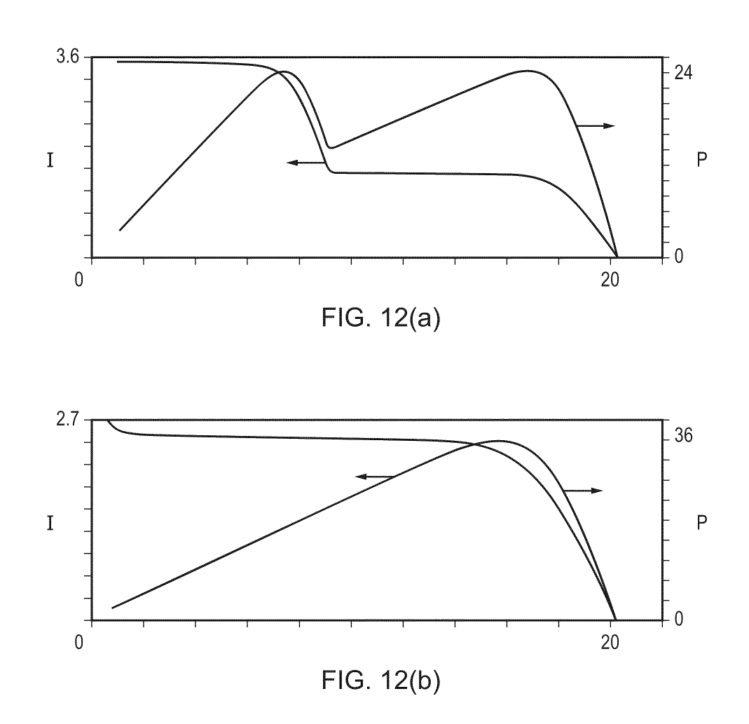

FIGS. 11 and 12 show simulated results for two segments, one being fully illuminated, (with illumination 700 W/m2), and the other partially shaded, at 300 W/m2. They respectively have Pm=26.27 W, Vmp=7.96V, and Imp=3.30 A, and Pm=10.77 W, Vpm=7.77V and Ipm=1.39 A, with IV and PV characteristics as shown at 1101, 1102 and 1101′ and 1102′ in FIGS. 11a and 11(b) respectively.

When simulating the two segments in series, one with all cells at 700 W/m2 and one with all cells at 300 W/m2, and with the delta converter still inactive, the simulation result is as shown in FIG. 12(a). As expected, FIG. 12(a) shows two maximum points. The point on the right-hand side is where both segments are active at the max power current of the shaded (300 W/m2) segment (˜1.4 A). The point on the left-hand side, which is the highest of the two, occurs when the shaded segment is bypassed (mid-point voltage Vsegment is indeed −0.55 V at this point) and the lit segment operates at its maximum power current. The fact that the maximum power is slightly lower (24.46 W here versus 26.27 W in FIG. 11(a)) is caused by the additional losses in the bypass diode (0.55V*3.28 A=1.8 W; 26.27 W-24.46 W=1.8 W).

The results of the simulation of operation with the delta converter active (with, as will be described below, almost zero voltage window and 100% efficiency; approaching ideal behaviour of a delta converter) is shown in FIG. 12(b). Due to the operation of the delta converter, there is now only one maximum power point remaining at 37 W. A closer inspection of the number reveals the following:

Firstly, consider current: the maximum power point current (for the combination) becomes 2.35 A. The ‘average’ maximum power point current for the two segments is actually (3.30+1.39)/2=2.35 A. So indeed, the delta converter ensures that the two sub-units ‘act’ as if they were irradiated with the average amount of light, leading to average current. And secondly, voltage: the maximum power point voltage becomes 15.75V and the midpoint voltage becomes 7.87V. Indeed 2*7.87V=15.74V, so as expected the delta converter makes the segment voltages equal. The MPP voltage per segment is therefore 7.87V. This voltage is indeed midway between the MPP voltage for 300 W/m2 (7.77V) and that for 700 W/m2 (7.96 V); (7.77+7.96)/2=7.87 V.

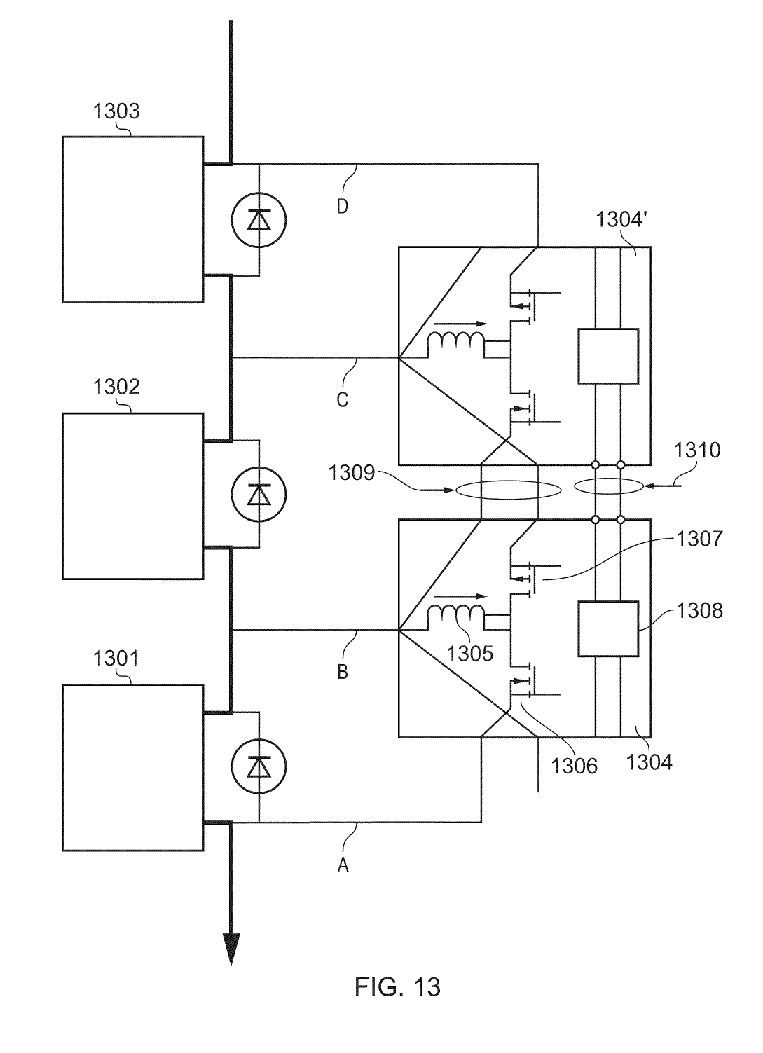

Most practical PV modules consist of 3 or 4 segments in series, each segment being equipped with one bypass diode. An example for 3 segments in a module was shown in FIG. 13. To implement local energy exchange for more than 2 segments connected in series, connections need to be made between the DC-DC converters. This is schematically indicated in FIG. 13 for 3 segments in series, as could be present inside one PV module. Three segments, at 1301, 1302 and 1303 are connected in series. An output from a supplementary power unit 1304, that is to say connections A and B, is connected in parallel with the first segment 1301. The input to the supplementary power unit 1304, that is to say connections A and C, is connected across two neighbouring segments 1301 and 1302. Similarly, an output from a second supplementary power unit 1304′, that is to say connections B and C, is connected in parallel with the second segment 1302. The input to the supplementary power unit 1304′, that is to say connections B and D, is connected across two neighbouring segments 1302 and 1303. Each supplementary power unit comprises a DC-DC converter, having an inductor 1305 connected between the output and the node between two switches 1306 and 1307, which together form a half-bridge circuit. The DC-DC converter is under control of a control unit 1308.

Thus, each converter is connected to its own node voltage (in the case of converter 1304, to B) and the node voltages of the next higher (C in this case) and lower (A in this case) segments. Therefore, when each converter makes its own node voltage available to its neighbours, a simple two-wire power interface 1309 can accommodate the connections between the converters, as indicated in the figure. An additional communication interface 1310 is possible, e.g. for synchronization of the converters or for accommodating a central switch-off function. As indicated in the figure, this may also be accommodated by means of an additional e.g. 2-wire communication interface (in other embodiments, a one-wire communication interface may be used, or in still other embodiments, a wireless interface based on e.g. the Zigbee standard). In this case each converter should have a level shifter to shift the communication signals from the previous converter level to the next converters level. Level shifters are needed, since the node voltages will not be equal and will increase in the upward direction of the string depicted in the FIG. 13. Note that since the DC-DC converters operate on node voltages in a string of segments, N−1 DC-DC converters are needed to accommodate a string of N segments in series. Finally, in normal operation, the bulk of the power (all power in case of no differences between groups of cells) is accommodated via the string. The connected DC-DC converters only operate on the power differences by exchanging chunks of energy between the sub-units or segment, in the appropriate direction and at the valid switching frequency of the converter.

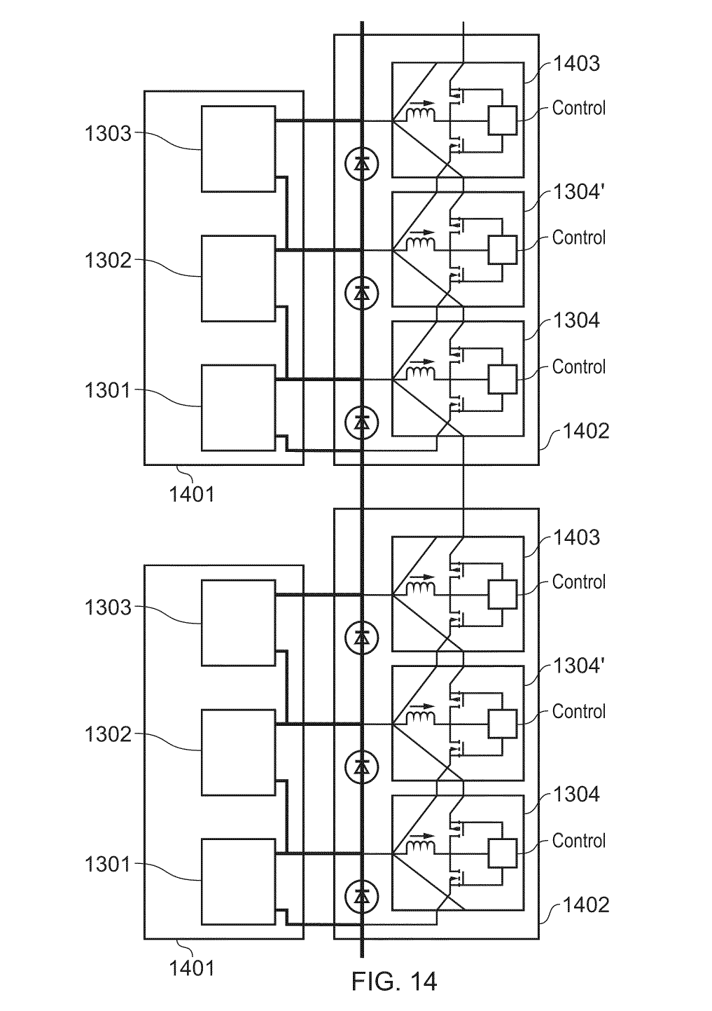

In cases where all segments inside a PV module are shaded or contaminated, all segments inside this PV module may be bypassed by their respective bypass diodes when other PV modules in the string generate enough power for the string to be installed at a string current at which they can operate at their maximum power point. In that case, connecting the converters in each PV module as shown in the previous embodiment would not suffice, since the voltages across each segment would be −Vf, where Vf is the forward voltage across a bypass diode. Even in cases where all PV modules receive enough sun light for the DC-DC converters inside the PV modules to be active, differences between PV modules also need to be cancelled by exchanging energy between the PV modules to obtain maximum power from the string. To accommodate for this situation, one additional ‘delta’ half-bridge DC-DC converter may be added to each junction box of each PV module. This additional DC-DC converter can then be used to connect to a DC-DC converter in the junction box of the next PV module in the string. Such an embodiment is depicted in FIG. 14. FIG. 14 shows two PV modules 1401 connected in series, each comprising three series-connected segments 1301, 1302 and 1303. As in the embodiment of FIG. 13, segments 1301 and 1302 each have, in parallel therewith, an associated respective DC-DC converter 1304, 1304′ acting as a supplementary power unit. However, the topmost segment 1303 of each module 1401 also now has an associated DC-DC converter 1403. The DC-DC converters for each module can conveniently be housed in a junction box 1402.

Note that as indicated, only one additional power wire now needs to be transported from the junction box of one PV module to that of another. As in the previous embodiment, only differences in power need to be transported across this additional power line. In state-of-the-art PV modules, the wiring occurs via the junction boxes, as indicated. This implies that in the embodiment of FIG. 14, 4 wires come out of the junction box 1402, two connected on each side. For the top PV module in a string, the top DC-DC converter in the junction box will remain unconnected and is therefore redundant. As a result, in a string with N segments in total, N−1 DC-DC converters will be in use to exchange energy between all segments in the string.

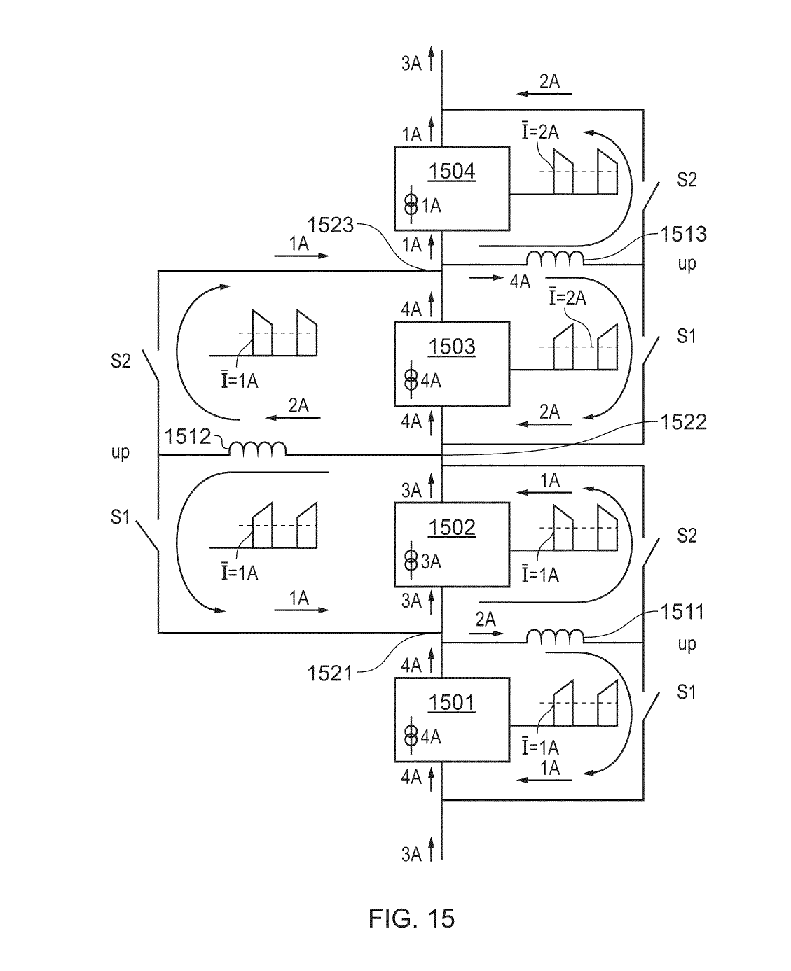

Operation of the DC-DC converters is illustrated in FIG. 15 for a simplified system. FIG. 15 depicts a module comprising four series-connected segments 1501, 1502, 1503, and 1504. Associated with the lower three segments are DC-DC converters having respective inductors 1511, 1512 and 1513. As mentioned above, it can equally be considered that the DC-DC converters are associated with respective nodes 1521, 1522 and 1523, between a first 1501 and second 1502, second 1502 and third 1503, and third 1503 and fourth 1504 segments respectively. Each DC-DC converter includes two switches, a first switch S1, which is arranged to connect to the inductor across the lower segment, and a second switch S2 arranged to connect the inductor across the higher respective segment. In this exemplary, simplified, example, the segments are either fully illuminated or partially shaded such that the photo-generated currents in first to fourth segments are 4 A, 3 A, 4 A and 1 A respectively. Assuming the segments all operate at the same voltage, and there is no overall power loss in the system, then the “average” string current will be 3 A. As shown in the figure, the inductors 1511, 1512, and 1513 sink a current of 2 A, 2 A and 4 A from the respective nodes. Each converter “redistributes” the current to the neighbouring nodes: thus the 2 A sunk from node 1521 is redistributed—1 A sourced to the bottom end of the module, and 1 A to node 1522; the 2 A sunk from node 1522 is redistributed—1 A to node 1521 and 1 A to node 1523, and the 4 A sunk from node 1523 is redistributed—2 A to node 1522 and 2 A to node the top end of the module. Finally, in the insert to each of the converter halves is shown schematically the current waveforms that are passing through that half of the converter. The time profile of the switched current is shown, along with the average current resulting.

Not shown in this simplified diagram are smoothing capacitors. These are needed, since the voltage ripple at both the input and output of the converter needs to be small to prevent the segments from cycling around their maximum power points. Therefore, input and output decoupling capacitors are preferred in all embodiments, as indicated in FIG. 8. In other words, voltage ripple at the input and output of the converters needs to be small, since the voltages at the segment terminals need to be DC, with only very small AC perturbations allowed. It will be appreciated that this requirement is no more onerous than that of known solutions without any DC-DC converters in place. Further, the inverter is also a switched-mode power supply with current ripple at the input (DC side) and therefore also in that case a sufficiently large input capacitor needs to be present. Of course, where there are multiple DC-DC converters, one capacitor may be placed across each segment. In that case, the capacitor C2seg shown in FIG. 8 is actually formed by two of the segment capacitors in series.

As shown in FIG. 15, all of the DC-DC converters are operating as up-converters (that is to say, the inductor sinks current from its node). It will be immediately apparent to the skilled person that in other configurations, it may be necessary for a converter to act as a down-converter, such that the inductor sources current into the node rather than sinks current from the mode. It will be equally apparent to the skilled person that a half-bridge converter as shown may be operable as either an up-converter or a down-converter, depending only on the control arrangement. In alternative, although less preferred, embodiments, an up-converter can be used in parallel with a down-converter for each DC-DC converter, only one (up or down) converter being active at any one time. Control of each converter may thus be simplified, at the expense of duplication of components such as inductors and switches.

Since the node voltage between two segments across which the half-bridge converter is present is controlled to half the voltage across the two segments in series, the duty cycle at which the DC-DC converter is operating is close to 50%, whether it is in up-conversion mode or in down-conversion mode. Because of this, an alternative embodiment, wherein the half-bridge converter is implemented as a dual-phase DC-DC converter with two parallel half bridges in anti-phase each with an individual coil, becomes attractive. This embodiment reduces the voltage ripple at both the input and output. This has a positive effect on the volume taken up by and the price of the passive components around the converter. First of all, the two coils in parallel will have the same volume as one coil in a single-phase implementation. The two capacitors, one at the input and one at the output of the dual-phase converter, will have an even smaller value and therefore volume and cost. The reason is that the ripple voltages at input and output become smaller and therefore capacitance values can be reduced to arrive at the same ripple voltage as for a single-phase implementation. Note that ripple cancellation between the two phases, operating at 180 phase difference, becomes optimum when the two phases operate at 50% duty cycle.

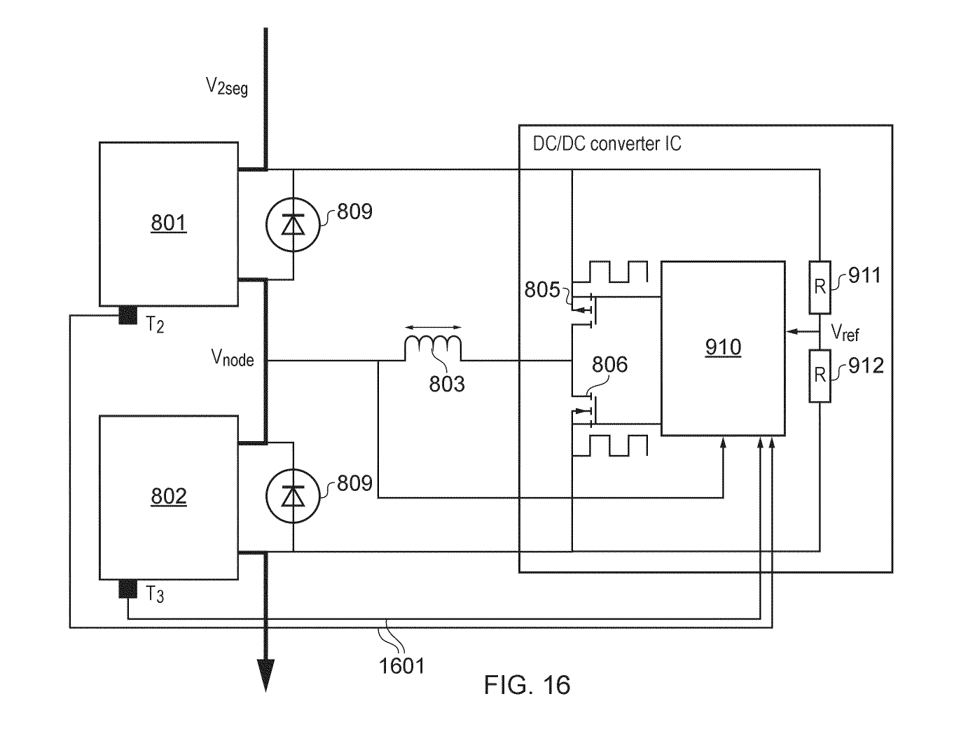

Since the operating characteristic of a segment, and in particular its operating voltage, depends on the temperature of the segments, in embodiments there can usefully be provided temperature sensing of the segments. FIG. 16 shows a DC-DC converter connected across two segments, and including temperature sensing. The arrangement is similar to that shown in FIG. 9; however, in this embodiment temperature sensors T2 and T3 are attached to or placed in close proximity to segments 801 and 802; by means of temperature sensor lines 1601, information on the segments temperatures is fed back to the controller 910. The controller may then capable of adjusting the node voltage of the node to take into account differences in temperature of the panels.

Absent such a temperature sensing mechanism, when a temperature difference exists between the two segments across which the half-bridge converter is connected, the converter will try to compensate for this difference too. This is undesired, since the half-bridge converter should only compensate for differences in Iins between segments. The temperature differences are expected to remain limited in practice. However, the undesired behaviour may be prevented by taking the temperature difference between segments into account in the control block, as shown in FIG. 16. The DC-DC converters may now be switched off in case the temperature difference between the segments becomes too large. Alternatively, the control window installed around Vref may be shifted taking into account the diode variations as a function of temperature.

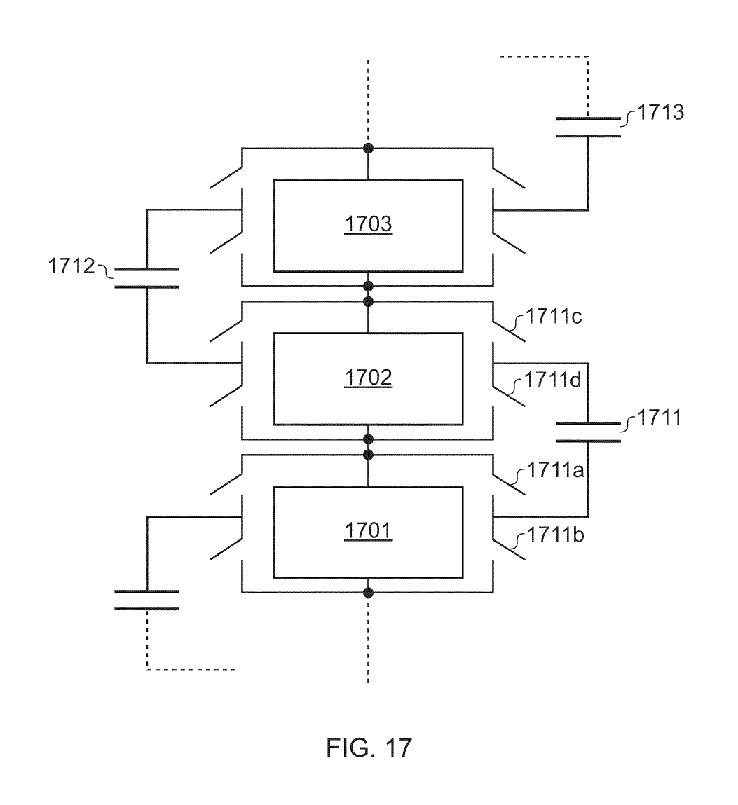

The embodiments described above have an inductor as the reactive element to store energy. However, voltage equalization between segments can also be effected using capacitive voltage converters. An example of such an embodiment is shown in FIG. 17. FIG. 17 shows schematically part of a module. Associated with series-connected segments 1701, 1702, 1703 etc. are capacitors 1711, 1712, etc. Either terminal of a capacitor is connectable to its associated node by mean of switches (1711a, 1711b), and a respective terminal is connectable to each neighbouring mode by means of switches (1711c, 1711d). By closing the switches in pairs (1711a, 1711c) and (1711b,1711d), the capacitors can first be connected in parallel to one segment with more energy, storing surplus energy in the capacitor, and then releasing it to the neighbouring segment by connecting it in parallel to that segment by means of closing the opposite pair of switches.

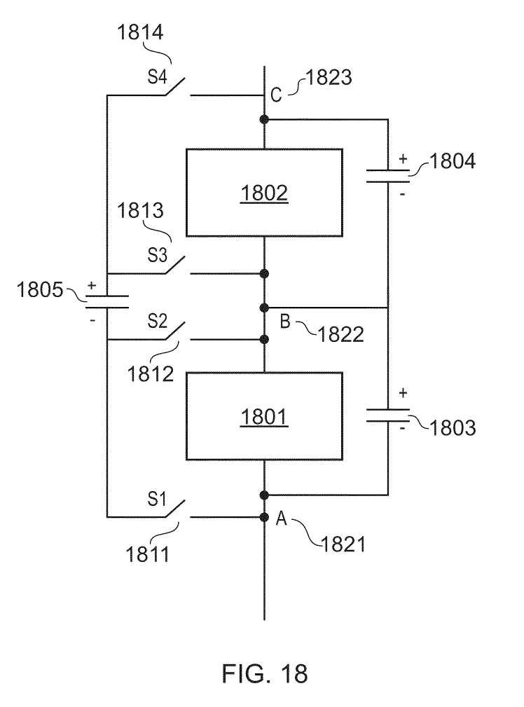

An example implementation for 2 segments is shown in FIG. 18. The Figure shows two series-connected segments, 1801, and 1802, having outer nodes A 1821 and C 1823, and a centre node B 1822 therebetween. In parallel with the respective segments are capacitors 1803 (between A 1821 and B 1822) and 1804 (between B 1822 and C 1823), which act as buffer capacitors. A further capacitor 1805, which can act as either a buffer or a fly capacitor, is connected by means of switches S11811, S2 1812, S3 1813 and S4 1814. One terminal of capacitor 1805 is connectable to either the outer node A 1821 or the centre node B 1822, by means of switches 51 1811 and S2 1812 respectively. Similarly, the other terminal of capacitor 1805 is connectable to either the centre node B 1822 or the outer node C 1823, by means of switches S3 1813 and S4 1814 respectively. In operation, the switches are closed in pairs, that is, S1 1811 and S3 1813, followed by S2 1812 and S4 1814, with a 50% duty cycle. Other duty cycles are also possible, but a 50% duty cycle is easy to implement. This results in capacitor 1805 alternately being connected across segments 1801 and 1802, and thereby tending to equalise the voltage across the two segments. Cascading this arrangement, for more than two segments, results in the configuration shown schematically in FIG. 17.

In order to avoid unnecessary power loss, in circumstances where the power consumption from the DC-DC converter is greater than the power which can be gained from balancing the sub-units—that is to say, where the DC-DC converter consumes more power than it saves—the DC-DC converter may be disabled or switched off. In practice, this is achieved by setting a voltage window around the mid-point voltage (V2seg/2), and disabling the converter, if the node between the sub-unit and the neighbouring sub-unit has a voltage within the voltage window. In embodiments in which separate DC-DC converters are used for up-conversion and down-conversion, such a window is important in order to ensure that the up- and down-converters are not operational at the same time. Moreover, provision of some hysteresis is useful to prevent bouncing between modes. Beneficially, disabling operation of the converter when it is within such a voltage window also assists in providing the control.

In summary, then, from one perspective, a photovoltaic unit is disclosed hereby, comprising a plurality of sub-units connected in series, each sub-unit having a main input and a main output, which main output is connected to the respective main input of a neighbouring sub-unit, each sub-unit further comprising a segment comprising one or more series-connected solar cells, and a supplementary power unit, wherein the supplementary power unit is configured to at least one of receive power from or supply power to the neighbouring sub-unit. The supplementary power unit is preferably a DC-DC converter, and arranged to exchange energy between neighbouring segments, without requiring a high-voltage connection across the complete string (of more than 2 segments). The converter may be inductive or capacitive. A DC-DC converter configured for use in such a unit is also disclosed, as is a method of controlling such a photovoltaic unit.

From reading the present disclosure, other variations and modifications will be apparent to the skilled person. Such variations and modifications may involve equivalent and other features which are already known in the art of photovoltaics, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A photovoltaic unit comprising a plurality of sub-units connected in series, each sub-unit having a main input and a main output, which main output is connected to the respective main input of a neighbouring sub-unit, each sub-unit further comprising
a segment comprising one or more series-connected solar cells, and a supplementary power unit,
wherein
the supplementary power unit is configured to at least one of source current to and
sink current from the main output of the respective neighbouring sub-unit
wherein the supplementary power unit comprises a DC-DC converter and has a first pair of terminals and a second pair of terminals, the first pair of terminals being connected one to each of the main input of the respective sub-unit and the main output of the neighbouring sub-unit. and the second pair of terminals being connected one to each of the main input of the respective sub-unit and the main output of the respective sub-unit. and
the supplementary power unit further comprises control means for controlling the series-connected switches,
the control means comprising a communication interface to the neighbouring sub-unit.

2. A photovoltaic unit as claimed in claim 1, wherein the DC-DC converter comprises two series-connected switches connected between the first pair of terminals and having a half-bridge node therebetween, and an inductor connected between the half-bridge node and the main output of the respective sub-unit.

3. A photovoltaic unit as claimed in claim 1, further comprising a capacitor connected between the main input and the main output of the respective sub-unit.

4. A photovoltaic unit as claimed in claim 1, wherein the control means is configured to control the switches such that the supplementary power unit operates as a half-bridge converter.

5. A photovoltaic unit as claimed in claim 1, wherein the control means further comprises a level shifter.

6. A photovoltaic unit as claimed in claim 1, wherein the supplementary power unit is disabled if the node between the sub-unit and the neighbouring sub-unit is within a predetermined voltage window around half the voltage between the input of the sub-unit and the output of the neighbouring sub-unit.

7. A photovoltaic unit as claimed in claim 2, further comprising a capacitor connected between the main input and the main output of the respective sub-unit.

8. A photovoltaic unit as claimed in claim 2, wherein the control means is configured to control the switches such that the supplementary power unit operates as a half-bridge converter.

9. A photovoltaic unit as claimed in claim 3, wherein the control means is configured to control the switches such that the supplementary power unit operates as a half-bridge converter.

10. A photovoltaic unit as claimed in claim 2, wherein the control means further comprises a level shifter.

11. A photovoltaic unit as claimed in claim 3, wherein the control means further comprises a level shifter.

12. A photovoltaic unit as claimed in claim 4, wherein the control means further comprises a level shifter.

13. A photovoltaic unit as claimed in claim 2, wherein the supplementary power unit is disabled if the node between the sub-unit and the neighbouring sub-unit is within a predetermined voltage window around half the voltage between the input of the sub-unit and the output of the neighbouring sub-unit.

14. A photovoltaic unit as claimed in claim 3, wherein the supplementary power unit is disabled if the node between the sub-unit and the neighbouring sub-unit is within a predetermined voltage window around half the voltage between the input of the sub-unit and the output of the neighbouring sub-unit.

15. A photovoltaic unit as claimed in claim 4, wherein the supplementary power unit is disabled if the node between the sub-unit and the neighbouring sub-unit is within a predetermined voltage window around half the voltage between the input of the sub-unit and the output of the neighbouring sub-unit.

16. A photovoltaic unit as claimed in claim 5, wherein the supplementary power unit is disabled if the node between the sub-unit and the neighbouring sub-unit is within a predetermined voltage window around half the voltage between the input of the sub-unit and the output of the neighbouring sub-unit.
